(19) United States
(12) Patent Application Publication
(10) Pub. No.: US 2025/0005748 A1
(43) Pub. Date: Jan. 2, 2025

(54) OPTIMIZED 2-D PROJECTION FROM 3-D CT IMAGE DATA

(71) Applicant: KONINKLIJKE PHILIPS N.V., EINDHOVEN (NL)

(72) Inventors: Axel Saalbach, HAMBURG (DE); Nicole Schadewaldt, NORDERSTEDT (DE); Matthias Lenga, MAINZ (DE); Heinrich Schulz, HAMBURG (DE)

(21) Appl. No.: 18/709,536

(22) PCT Filed: Nov. 17, 2022
(86) PCT No.: PCT/EP2022/082173

§ 371 Date: May 13, 2024

Related U.S. Application Data
(60) Provisional application No. 63/281,775, filed on Nov. 22, 2021.

(51) Int. Cl. G06T 7/00; G06T 11/00

(52) U.S. Cl. CPC G06T 7/0012; G06T 11/008; G06T 2207/10081; G06T 2207/20081; G06T 2207/20084

(57) ABSTRACT

A computing system (122) includes a memory (130) with instructions (132) including a digitally reconstructed radiograph view optimization instruction (134), a processor (128) configured to execute the digitally reconstructed radiograph view optimization instruction to generate a plurality of digitally reconstructed radiographs based on a plurality of different sets of projection parameters and three-dimensional computed tomography image data and to identify an optimal sub-set of the plurality of digitally reconstructed radiographs for reading for the reason for acquiring the three-dimensional computed tomography image data, and an output device (126) configured to display the identified optimal sub-set of the plurality of digitally reconstructed radiographs for reading.

### FIELD

The following generally relates to medical imaging and more particularly to an optimized two-dimensional (2-D) projection from three-dimensional (3-D) computed tomography (CT) image data.

### BACKGROUND

An X-ray radiograph is a 2-D projection image of the total X-ray absorption from a given view direction. A typical chest X-ray radiograph includes a posterior anterior (PA), an anterior posterior (AP) and/or a lateral (LAT) 2-D projection image. For a PA 2-D projection image, the subject stands with their front towards the film/flat panel sensor and their back facing the X-ray source, and X-rays traverse from their back (posterior) to their front (anterior) to the film/flat panel sensor. For an AP 2-D projection image, the subject's back is towards the film/flat panel sensor and their front is toward the X-ray source. For a LAT 2-D projection image, one shoulder/arm is towards the film/flat panel sensor and the other shoulder/arm is towards the X-ray source.

A CT image is 2-D image of a cross-sectional slice/slab (i.e., a volume) through the body. Three-dimensional CT image data includes multiple (adjacent and/or overlapping) slices/slabs acquired along the long axis of body. Three-dimensional CT image data can be used to simulate an X-ray 2-D projection image. Such an image has been referred to as a Digitally Reconstructed Radiograph (DRR). While 3-D CT image data are typically read by radiologists on a slice by slice level, DRRs provide a compact representation of the overall image data and allow for fast and efficient detection of many diseases.

A DRR can be generated to simulate a PA 2-D projection image, an AP 2-D projection image and/or a LAT 2-D projection image. Since the 3-D CT image data is stored as digital data, DRRs can also be generated from other directions (i.e., other than PA, AP and LAT directions), including directions that cannot be acquired with conventional X-ray radiography. A set of DRRs in such other from provides additional information for a reading clinician, including information that may not be readily visible in PA, AP and/or LAT X-ray 2-D projection images or PA, AP and/or LAT DRRs. Depending on the reason for the image, a DRR in the PA, AP and/or LAT directions may provide an “optimal” view to the reading clinician. However, the PA, AP and LAT DRR may be “sub-optimal” to the reading clinician for the reason for the imaging examination, with the “optimal” direction(s) to the reading clinician from a DRR generated for a direction other than the PA, AP or LAT directions.

For example, an object of interest (or at least a portion of interest thereof) may not be visible or readily visible in a PA, AP or LAT DRR, but adequately visible in a DRR for a different direction for the reason for the imaging examination. However, to determine which DRR in a set of DRRs is preferred by a reading clinician, the reading clinician has to assess all of the DRRs from all of the directions in the set of DRRs. Unfortunately, this can be tedious and/or time consuming, and, depending on the number DRRs, not practical. As such, there is an unresolved need for another approach for 2-D projection image/DRR visualization from 3-D CT image data.

### SUMMARY

Aspects described herein address the above-referenced problems and/or others.

As described herein, in one embodiment, a system and/or a method identifies and displays an optimal DRR(s) from a set of DRRs generated from 3-D CT image data. In one instance, this facilitates and/or speeds up image reading and diagnosis as the reading clinician does not have to review all of the DRRs to identify a DRR(s) best suited for the reason for the imaging examination. The system, in general, includes a module with instructions to generate DRRs based on certain projection parameters and a module with instructions to identify the optimal DRR(s) of the generated DRR for reading by a reading clinician for the reason for the imaging examination.

In one aspect, a computing system includes a memory with instructions including a digitally reconstructed radiograph view optimization instruction. The computing system further includes a processor configured to execute the digitally reconstructed radiograph view optimization instruction to generate a plurality of digitally reconstructed radiographs based on a plurality of different sets of projection parameters and three-dimensional computed tomography image data and to identify an optimal sub-set of the plurality of digitally reconstructed radiographs for reading for the reason for acquiring the three-dimensional computed tomography image data. The computing system further includes output device configured to display the identified optimal sub-set of the plurality of digitally reconstructed radiographs for reading.

In another aspect, a computer-implemented method includes generating a plurality of digitally reconstructed radiographs based on a plurality of different sets of projection parameters and three-dimensional computed tomography image data. The computer-implemented method further includes identifying an optimal sub-set of the plurality of digitally reconstructed radiographs for reading for the reason for acquiring the three-dimensional computed tomography image data. The computer-implemented method further includes displaying the identified optimal sub-set of the plurality of digitally reconstructed radiographs for reading.

In another aspect, a computer-readable storage medium stores instructions, which, when executed by a processor of a computer, cause the processor to generate a plurality of digitally reconstructed radiographs based on a plurality of different sets of projection parameters and three-dimensional computed tomography image data, identify an optimal sub-set of the plurality of digitally reconstructed radiographs for reading for the reason for acquiring the three-dimensional computed tomography image data, and display the identified optimal sub-set of the plurality of digitally reconstructed radiographs for reading.

Those skilled in the art will recognize still other aspects of the present application upon reading and understanding the attached description.

### BRIEF DESCRIPTION OF THE DRAWINGS

The invention may take form in various components and arrangements of components, and in various steps and arrangements of steps. The drawings are only for purposes of illustrating the embodiments and are not to be construed as limiting the invention.

FIG. 1 diagrammatically illustrates an example system including a computing system with instructions, in accordance with an embodiment(s) herein.

FIG. 2 diagrammatically illustrates an example of DRR view optimization instructions of the instructions, in accordance with an embodiment(s) herein.

FIG. 3 diagrammatically illustrates a representation of 3-D CT image data including anatomy and an object of interest, in accordance with an embodiment(s) herein.

FIG. 4 diagrammatically illustrates an example of a 2-D projection through the 3-D CT image data of FIG. 3, in accordance with an embodiment(s) herein.

FIG. 5 diagrammatically illustrates an example of a different 2-D projection through the 3-D CT image data of FIG. 3, in accordance with an embodiment(s) herein.

FIG. 6 diagrammatically illustrates a variation of the DRR view optimization instructions of FIG. 2, in accordance with an embodiment(s) herein.

FIG. 7 diagrammatically illustrates an example heat map, in accordance with an embodiment(s) herein.

FIG. 8 diagrammatically illustrates another variation of the DRR view optimization instructions of FIG. 2, in accordance with an embodiment(s) herein.

FIG. 9 diagrammatically illustrates an example method, in accordance with an embodiment(s) herein.

FIG. 10 diagrammatically illustrates another example method, in accordance with an embodiment(s) herein.

### DESCRIPTION OF EMBODIMENTS

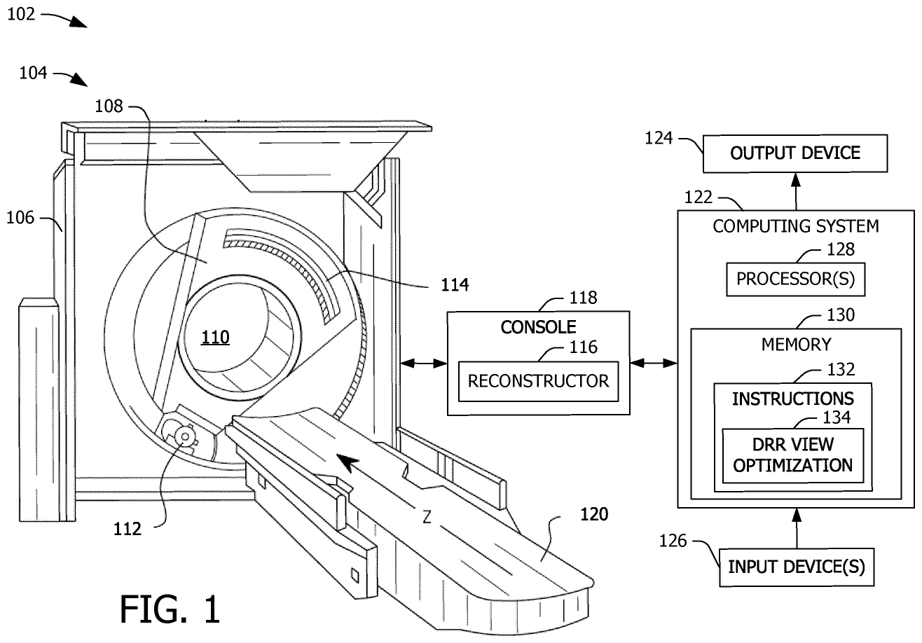

FIG. 1 diagrammatically illustrates an example system 102, which includes an imaging system 104 such as a computed tomography (CT) scanner. The imaging system 104 includes a generally stationary gantry 106 and a rotating gantry 108, which is rotatably supported by the stationary gantry 106 and configured to rotate around an examination region 110 about a “z” axis. The imaging system 104 further includes a radiation source 112, such as an X-ray tube, that is rotatably supported by the rotating gantry 108, and is configured to rotate with the rotating gantry 108 and emit X-ray radiation that traverses the examination region 110.

The imaging system 104 further includes a radiation sensitive detector array 114 that subtends an angular arc opposite the radiation source 112 across the examination region 110. The array 114 detects X-ray radiation traversing the examination region 110 and generates projection data (line integrals) indicative thereof. The imaging system 104 further includes a reconstructor 116 that is configured to reconstruct the projection data and generate 3-D CT image data indicative of the examination region 110. The imaging system 104 further includes a subject support 120, such as a couch, configured to support an object or subject in the examination region 110.

The imaging system 104 further includes an operator console 118. In one instance a console application of the operator console 118 provides an option for a “standard” dose or “lower” dose acquisition. The literature, e.g., Kroft et al., “Added Value of Ultra-low-dose Computed Tomography, Dose Equivalent to Chest X-ray Radiography, for Diagnosing Chest Pathology,” Journal of Thoracic Imaging, 34(3), March 2019, indicates that an average effective dose for an X-ray radiograph is 0.10 millisievert (mSv), an average effective dose for a standard chest CT is 5.5 mSv (Europe)/8 mSv (United States), and effective dose below 1 mSv such as equivalent to X-ray radiography (0.10 mSv) is feasible for detecting pathologies with a sensitivity comparable to standard dose CT.

Lower dose, as utilized herein, at least includes a dose of less than or equal to 1 mSv. Kroft et al. further indicates that with their study the usage of lower dose CT improves perceived confidence with a reduction in false-positives and false-negatives relative to X-ray radiography (100% for lower dose CT versus 98% for X-ray radiography), had an in-room time that is similar to X-ray radiography (less than 3 minutes for lower dose CT versus less than 2 minutes for X-ray radiography), and had an effective dose (0.071 mSv) that was less than the mean effective dose of X-ray radiography (0.10 mSv). As such, DRRs generated from lower dose 3D CT image data may provide a preferred presentation for reading by a reading clinician.

The system 102 further includes a computing system 122, such as a computer, a workstation, etc., along with a human readable output device 124, such as a display monitor, etc., and an input device 126, such as a keyboard, mouse, etc. The computing system 122 further includes a processor 128 (e.g., a central processing unit (CPU), a microprocessor, graphics processing unit (GPU), and/or other processor) and a memory/computer readable storage medium 130 (which excludes transitory medium) such as physical memory, a memory device, and/or other non-transitory storage medium. The memory 130 includes instructions 132. The processor 128 is configured to execute one or more of the instructions 132.

The instructions 132 include at least a DRR view optimization instruction 134. As described in greater detail below, in one non-limiting embodiment, the DRR view optimization instruction 134, when executed by the processor 128, generates a plurality of 2-D projection images (DRRs) based on a set of projection parameters (view directions) and the 3-D CT image data, and determines a sub-set (i.e., one or more, but less than all) of the plurality of the 2-D projection images to present for reading by a reading clinician. In one instance, this provides for an initial fast assessment relative to X-ray radiography, facilitating and speeding up image reading and diagnosis, e.g., as the reading clinician does not have to assess all of the plurality of the 2-D projection images to find the optimal DRR, if they chose not to.

In the illustrated embodiment, the DRR view optimization instruction 134 is in the computing system 122, which is separate from the imaging system 104. The computing system 122 can be a Picture Archiving and Communications System (PACS), a visualization workstation, and/or other computing device. In this instance, 3-D CT image data and/or other electronic information can be transferred between the console 118 and the computing system 122 via the DICOM (Digital Imaging and Communications in Medicine) format and/or other format(s). In another embodiment, at least part of the DRR view optimization instructions 134 is implemented by the console 118. In yet another embodiment, the computing system 122 is the operator console 118.

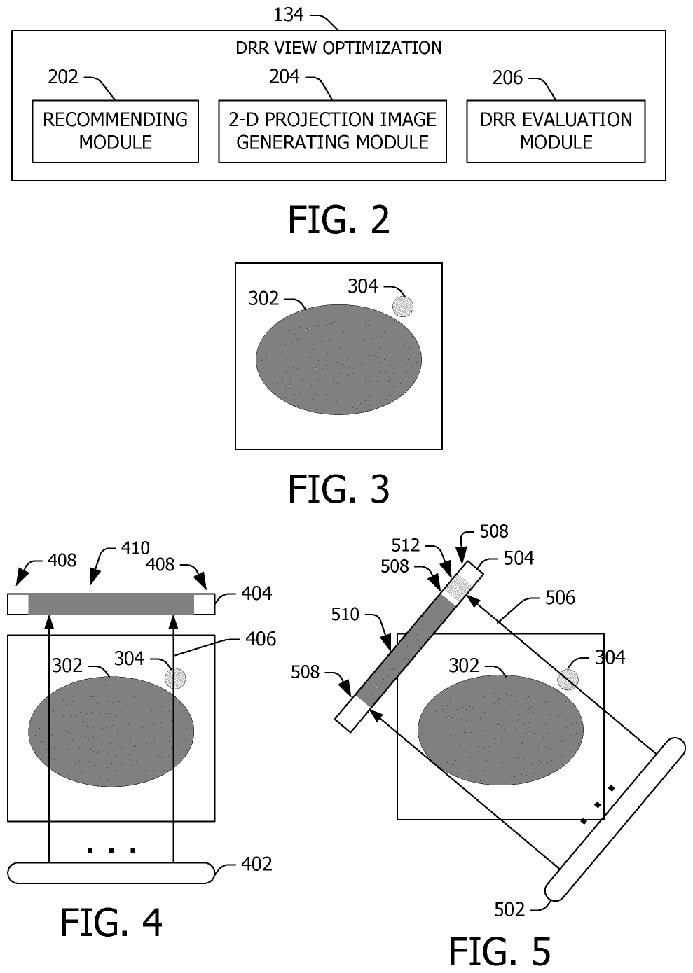

FIG. 2 diagrammatically illustrates an example of the DRR view optimization instruction 134. The DRR view optimization instruction 134 processes the 3-D CT image data, which can be standard or lower dose image data, from the imaging system 104 and/or other system.

In this example, the DRR view optimization instruction 134 includes a recommending module 202 configured to recommend image projection parameters for DRR generation such as a direction of the projection. In one instance, the recommending module 202 recommends projections similar to chest X-ray radiography such as PA, AP and/or LAT view directions. Additionally, or alternatively, the recommending module 202 determines other projections, including directions from other angles, an arbitrary direction(s), a curved trajectory direction(s), a view direction(s) based on all of or a sub-set of the slabs/slices of the 3-D CT image data, view directions based on user preferences, view directions based on directions with a highest interest to a reading clinician, view directions based on reading clinician confidence, etc. As utilized herein, a predefined list of parameters includes at least standard projections (PA, AP and/or LAT) and user preferences.

In this example, the DRR view optimization instruction 134 further includes a 2-D projection image generating module 204 configured to generate the plurality of DRRs based on the identified image projection parameters and the 3-D CT image data. An example of a suitable algorithm for generating DRRs is described in Ruijters et al., “GPU-accelerated digitally reconstructed radiographs,” BioMED '08: Proceedings of the Sixth IASTED International Conference on Biomedical Engineering, 6 Feb. 2008, Pages 431-435. With this example, generation of a DRR comprises the calculation of line integrals over the Hounsfield values along the rays through the voxel volume, where the rays are defined by the focal spot of the (virtual) X-ray source and a discrete point on the (virtual) detector grid.

In this example, the DRR view optimization instruction 134 further includes a DRR evaluation module 206 configured to evaluate the set of DRRs to identify the sub-set of the generated DRRs and to present the sub-set of DRRs for reading by a reading clinician. In one instance, the DRR evaluation module 206 employs artificial intelligence (AI) to facilitate identifying an object (e.g., a pathology, etc.) and/or characteristic (e.g., an abnormality, etc.) of interest in the DRRs. A non-limiting example of such AI is a trained deep learning network (DLN).

With a DLN trained to detect pathologies in the DRRs, the output indicates a diagnostic value of each DRR based on the network's response, and at least the DRR(s) with a likelihood above a predetermined threshold, a highest likelihood, etc. for a pathology of interest is presented, via the output device monitor 124, at least as a starting point for the reading clinician. In one instance, this DRR(s) may be shown simultaneously with a PA, AP and/or LAT DRR (if it is not a PA, AP and/or LAT) so that the reading clinician also has conventional X-ray radiology type views. However, such other views do not have to also be displayed.

In one instance, where there are multiple DRR(s) satisfying the optimal view criteria, the reading clinician can scroll through the DRR(s) and/or more than one DRR can be concurrently displayed. In another instance, where only a single DRR is displayed, the reading clinician can request presentation of the next DRR most likely to include the object of interest and/or other DRR. The reading clinician can also set filters such as preferred views and/or views to exclude, which may take priority over the result of the trained DLN. In another instance, the reading clinician can also select a DRR to display such as PA, AP and/or LAT DRR.

The DLN can be trained to detect a specific pathology(s). Additionally, or alternatively, the DLN can be trained to detect an abnormality(s). Additionally, or alternatively, the DLN can be trained based on clinician rating. For example, for training, a clinician can view a set of DRRs and rate each as interested in or not interested, using a binary scale (e.g., 0 or 1, yes or no, etc.), a discrete scale with more than two options, and/or a continuous scale (e.g., where 0=not interested, 1=interested, and a value therebetween indicates an interest level between not interested and interested). Additionally, or alternatively, the DLN can be trained based on direction typically used by reading clinicians for reason of the imaging examination.

In yet another instance, e.g., when the number of projection parameters results in a large set of DRRs such that the evaluation of the DRRs might become time consuming (e.g., as determined by the healthcare entity, reading clinician, etc.), the recommending module 202 predicts projection parameters, e.g., based on the 3-D CT image data. In one instance, this includes inferring projection directions from the 3-D CT image data using a regression and/or other approach. For example, using a regression approach based on a deep convolutional neural network (CNN), the network can be used to predict projection parameters directly from 3-D CT image Data.

Given a training dataset with images and projection parameters corresponding to, e.g., DRRs with high diagnostic value (based on ratings from clinicians), the network can be trained using standard techniques. A suitable neural network includes, but it not limited to a set of interconnected layer comprising convolutional layer, fully connected layer, pooling layer, normalization layer, etc.

FIGS. 3, 4 and 5 show a non-limiting example using a DLN trained to detect a pathology(s). FIG. 3 shows a representation of 3-D CT image data, which includes anatomy 302 (darker gray) and a pathology 304 (lighter gray).

FIG. 4 shows a virtual source 402 and a virtual detector 404 for a first view direction for a first set of projection parameters. From this direction, a projection 406 that traverses the pathology 304 also traverses the anatomy 302. As a result, the anatomy 302 obscures the pathology 304 in the DRR as shown at the virtual detector 404, where white areas 408 represent no anatomy or pathology and the darker gray area 410 represents only anatomy and the superposition of anatomy and pathology. In this case, the opaqueness of the anatomy 302 obscures detection of the pathology 304 in the DRR. Generally, the view direction in FIG. 4 represents an X-ray radiology PA or AP view, and the pathology 304 in this example is not visibly discernable in the DRR.

FIG. 5 shows a different virtual source 502 and a different virtual detector 504 for a different view direction for a different set of projection parameters. From this direction, a projection 506 that traverses the pathology 304 does not traverses the anatomy 302. As a result, both the anatomy 302 and the pathology 304 are visually discernable in the DRR as shown at the virtual detector 504, where the white areas 508 represent no anatomy or pathology, the darker gray area 510 represents only anatomy, and the lighter gray are 512 represents only pathology.

In this example, the DLN of the DRR evaluation module 206 trained to detect the pathology 304 is likely not to detect the pathology 304 in the DRR generated with the direction in FIG. 4. However, the DLN of the DRR evaluation module 206 trained to detect the pathology 304 would detect the pathology 304 in the DRR generated with the direction in FIG. 5. As such, the DRR evaluation module 206 would flag the DRR generated with the direction in FIG. 5 as being of diagnostic value and present it for reading.

Where the DLN detects the pathology in multiple DRRs, the DLN identify one or more of the multiple DRRs to display. Again, this decision can be based on user preferences, a view direction typically used by the reading clinician and/or healthcare entity, characteristics of the pathology of interest to the reading clinician, and/or other information. In one or more of these variations, the results of the DLN can be used to further train the DLN.

Although in this example the DRR where the pathology 304 is unobstructed by the anatomy 302 is considered the optimal DRR, in other instances the optimal DRR is not necessarily a fully unobstructed DRR. For example, a DRR with a partially obstructed pathology may reveal a portion of interest of the pathology more clearly than a DRR with an unobstructed view of the pathology. For example, the portion of interest may be a particular region that more visible in the view with the partially obstructed pathology relative to the view with the unobstructed pathology.

Variations are contemplated.

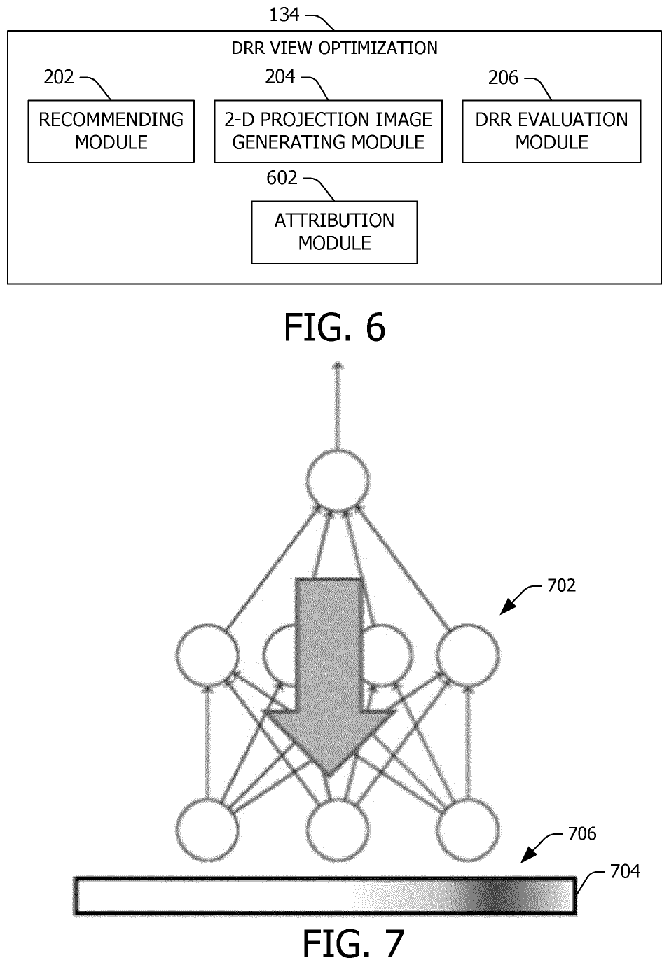

In FIG. 6, the DRR view optimization instruction 134 further includes an attribution module 602. The attribution module 602 is configured to highlight detection results. For instance, in this embodiment, the attribution module 602 generates and displays a “heat” map highlighting the detected pathology. An example heat map is shown in FIG. 7, which shows at least a portion of a DLN 702 and a heat map 704 with highlighting 706 corresponding to the portion 512 identified in FIG. 5, which is where the pathology 304 is located.

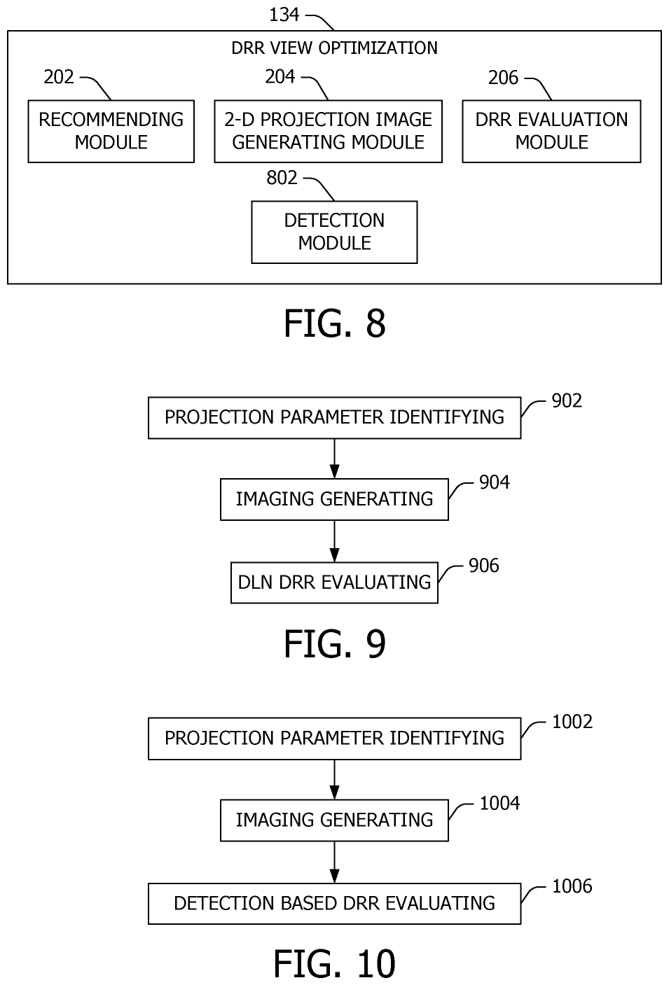

In FIG. 8, the DRR view optimization instruction 134 further includes a detection module 802. With this embodiment, the module 802 applies a detection algorithm to the 3-D CT image data to identify a location and/or an extent of an object. Given the location and extent, as well as any overlap with surrounding anatomy in the projection, the DRR evaluation module 206 utilizes the extent of the object in the projection (e.g. area, diameter, etc.) and/or a visibility (average absorption of the pathology/average total absorption, etc.). For example, in one instance the processor 128 applies a detection algorithm to at least a sub-portion of the 3-D CT image data and evaluates the DRRs based on a visibility of detected structures in the digitally reconstructed radiographs. Furthermore, the object could be highlighted in the projection (e.g. in terms of a color overlay, etc.) using the results from the analysis of the 3-D CT image data (e.g. a segmentation mask).

In yet another embodiment, the DRR view optimization instruction 134 includes the attribution module 602 and the segmentation module 802, and/or other modules.

FIG. 9 diagrammatically illustrates an example method for detecting and labelling vertebrae of a spine in volumetric image data, in accordance with an embodiment(s) herein.

It is to be appreciated that the ordering of the acts of one or more of the method is not limiting. As such, other orderings are contemplated herein. In addition, one or more acts may be omitted, and/or one or more additional acts may be included.

A projection parameter identifying step 902 identifies at least a set of projection directions for generating DRRs, as described herein and/or otherwise.

An imaging generating step 904 generates a plurality of DRR based on the identified projection directions, as described herein and/or otherwise.

A deep learning network (DLN) DRR evaluating step 906 selects and presents one of the DRRs in which tissue of interest is detected to present for reading by a reading clinician, as described herein and/or otherwise.

An optional attribution step generates a presentation that highlights the location of the detected pathology, as described herein and/or otherwise.

FIG. 10 diagrammatically illustrates an example method for detecting and labelling vertebrae of a spine in volumetric image data, in accordance with an embodiment(s) herein.

It is to be appreciated that the ordering of the acts of one or more of the method is not limiting. As such, other orderings are contemplated herein. In addition, one or more acts may be omitted, and/or one or more additional acts may be included.

A projection parameter identifying step 1002 identifies at least a set of projection directions for generating DRRs, as described herein and/or otherwise.

An imaging generating step 1004 generates a plurality of DRR based on the identified projection directions, as described herein and/or otherwise.

A detection based DRR evaluating step 1006 selects and presents one of the DRRs in which tissue of interest is detected to present for reading by a reading clinician, as described herein and/or otherwise.

An optional attribution step generates a presentation that highlights the location of the detected pathology, as described herein and/or otherwise.

The above methods can be implemented by way of computer readable instructions, encoded, or embedded on the computer readable storage medium, which, when executed by a computer processor(s), cause the processor(s) to carry out the described acts. Additionally, or alternatively, at least one of the computer readable instructions is carried out by a signal, carrier wave or other transitory medium, which is not computer readable storage medium.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims.

The word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage.

A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A computing system, comprising:
a memory with instructions including a digitally reconstructed radiograph view optimization instruction;
a processor configured to execute the digitally reconstructed radiograph view optimization instruction to generate a plurality of digitally reconstructed radiographs based on a plurality of different sets of projection parameters and three-dimensional computed tomography image data and to identify an optimal sub-set of the plurality of digitally reconstructed radiographs to be read for a same reason that the three-dimensional computed tomography image data was acquired; and
an output device configured to display the identified optimal sub-set of the plurality of digitally reconstructed radiographs for reading.

2. The system of claim 1, wherein the processor is further configured to determine the different sets of projection parameters based on a pre-defined list of projection parameters.

3. The system of claim 1, wherein the different sets of projection parameters include projection parameters for generating a digitally reconstructed radiograph along a curved trajectory.

4. The system of any claim 1, wherein the different sets of projection parameters include projection parameters for generating a digitally reconstructed radiograph in an arbitrary direction.

5. The system of claim 1, wherein the processor employs artificial intelligence to identify the optimal sub-set of the plurality of digitally reconstructed radiographs.

6. The system of claim 5, wherein the artificial intelligence includes a Deep Learning network.

7. The system of claim 5, wherein the identification is based on a classification algorithm.

8. The system of claim 5, wherein the identification is based on a regression algorithm.

9. The system of claim 5, wherein the identification is based on a detection algorithm.

10. The system of any of claim 9, wherein the processor is further configured to generate and display a heat map based on a result of the detection algorithm, wherein the heat map highlights a region of interest in the optimal sub-set of the plurality of digitally reconstructed radiographs.

11. The system of claim 9, wherein the processor is further configured to apply a detection algorithm to at least a sub-portion of the three-dimensional computed tomography image data and evaluate the digitally reconstructed radiographs based on a visibility of structures detected in the digitally reconstructed radiographs.

12. The system of claim 11, wherein the processor evaluates the digitally reconstructed radiographs based on a size of the detected structures in the digitally reconstructed radiographs.

13. The system of claim 11, wherein the processor is further configured to generate and display a heat map based a result of the detection algorithm and a result of the segmentation, wherein the heat map highlights a region of interest in the optimal sub-set of the plurality of digitally reconstructed radiographs.

14. The system of claim 1, wherein the processor is further configured to identify an optimal view direction of the sub-set directly from the three-dimensional computed tomography image data.

15. A computer-implemented method, comprising:
generating a plurality of digitally reconstructed radiographs based on a plurality of different sets of projection parameters and three-dimensional computed tomography image data;
identifying an optimal sub-set of the plurality of digitally reconstructed radiographs to be read for a same reason that the three-dimensional computed tomography image data was acquired; and
displaying the identified optimal sub-set of the plurality of digitally reconstructed radiographs for reading.

16. The computer-implemented method of claim 15, further comprising:
determining the different sets of projection parameters using regression to infer projection directions from the three-dimensional computed tomography image data.

17. The computer-implemented method of, claim 15, further comprising:
identifying the optimal sub-set of the plurality of digitally reconstructed radiographs determining based on a trained convolutional neural network.

18. A computer-readable storage medium storing computer executable instructions, for detecting and labelling vertebrae of a spine in volumetric image data, which when executed by a processor of a computer cause the processor to:
generate a plurality of digitally reconstructed radiographs based on a plurality of different sets of projection parameters and three-dimensional computed tomography image data;
identify an optimal sub-set of the plurality of digitally reconstructed radiographs to be read for a same reason that the three-dimensional computed tomography image data was acquired; and
display the identified optimal sub-set of the plurality of digitally reconstructed radiographs for reading.

19. The computer-readable storage medium of claim 17, wherein the computer executable instructions further cause the processor to:
determine the different sets of projection parameters using regression to infer projection directions from the three-dimensional computed tomography image data.

20. The computer-readable storage medium of claim 19, wherein the computer executable instructions further cause the processor to:
identify the optimal sub-set of the plurality of digitally reconstructed radiographs determining based on a trained convolutional neural network.
